(19) United States
(12) Patent Application Publication
(10) Pub. No.: US 2009/0219302 A1
(43) Pub. Date: Sep. 3, 2009

(54) ELECTRONIC DEVICE CAPABLE OF PROCESSING IMAGE AND METHOD THEREOF

(75) Inventors: XIAO-GUANG LI, Shenzhen City (CN); CHIA-YU CHENG, Tu-Cheng (TW); KUAN-HONG HSIEH, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/336,507

(22) Filed: Dec. 16, 2008

(30) Foreign Application Priority Data
Feb. 29, 2008 (CN) 200810065460.7

(51) Int. Cl. G09G 5/00; G06K 9/32

(52) U.S. Cl. 345/660; 382/298

(57) ABSTRACT

A method for processing an image before the image is displayed on a display unit, including: obtaining information of the image and judging the aspect ratio of the image whether equal to the aspect ratio of the display unit; if equality, then display the image on the display unit; else, stretching the image to make the size of the image equal to the size of the display unit; blurring the stretched image; covering the blurred image with the original image and obtaining a combination image; displaying the combination image on the display unit. Present invention also provides an electronic device with the image processing function.

### BACKGROUND

1. Technical Field

The disclosure relates to electronic devices and, particularly, to an electronic device capable of processing an image and method thereof.

2. General Background

Many electronic devices, e.g., computers, mobile phones, digital photo frames, are capable of storing and displaying images. Accordingly, people may store their images in multiple devices for sharing among multiple devices.

Usually, different electronic devices have different aspect ratio. For example, the display of a computer may have an aspect ratio of 16:9 and the digital photo frame 4:3, and therefore, an image may be more suitable for viewing in one than in the other, for example, an image with the ratio of 16:9, is fine for the computer but not the digital photo frame. Usually, when the aspect ratio of an image does not match the aspect ratio of the electronic device it is being viewed with, the image by default will be displayed in the center of the viewing area, and nothing but black areas displayed in those areas not used by the image. Even with current resizing techniques, black areas are still common on a display when showing an image with an incompatible aspect ratio.

Therefore, it is necessary to provide an electronic device and a method to overcomes the above-identified deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device capable of processing images according to an exemplary embodiment.

FIG. 2 is a flowchart illustrating a method for processing images applied in the electronic device of FIG. 1 according to an exemplary embodiment.

### DETAILED DESCRIPTION OF THE EMBODIMENTS

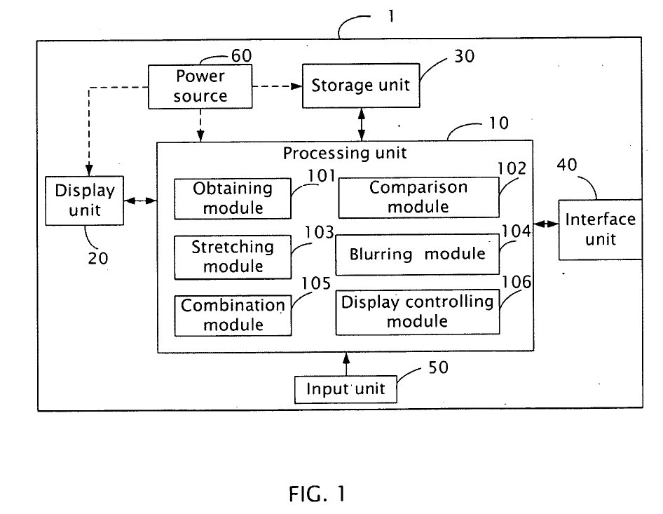

Referring to FIG. 1, the electronic device 1 includes a processing unit 10, a display unit 20, a storage unit 30, an interface unit 40, an input unit 50, and a power source 60.

The interface unit 40 is configured to connect to an external electronic device (not shown). The external device can be a storage card (for example, a secure digital (SD) card, a compact flash (CF) card) or another electronic device (for example, a digital camera, a mobile phone, or a computer). The storage unit 30 is configured to store media files. The media files may include, but are not limited to, audio files, digital images/images, videos, etc. In the exemplary embodiment, the storage unit 30 is a built-in storage unit, such as a flash memory, a micro drive, and so on. The display unit 20 is configured to display and/or play the media files.

The input unit 50 is configured to generate instructions in response to user's operations. The input unit 50 can be an input key (button), a knob, and the like. The power source 60 is configured to provide power to a plurality of functional units of the electronic device 1, such as the processing unit 10 and the display unit 20.

The processing unit 10 includes an obtaining module 101, a comparison module 102, a stretching module 103, a blurring module 104, a combination module 105, and a display controlling module 106.

The obtaining module 101 is configured to obtain information of an image stored in the storage unit 40 or in the external electronic device when the input unit 50 generates an instruction to display the image in response to an operation thereon. The comparison module 102 is configured to obtain an aspect ratio of the image (hereinafter, “the image ratio”) according to the information contained in the image file, and to obtain an aspect ratio of the display unit 20 (hereinafter, “the display unit ratio”). The comparison module 102 is further configured to compare the image ratio with the display unit ratio and determines whether the image ratio matches the display unit ratio.

If the image ratio is larger than the display unit ratio, then without adjustment to the image, the display unit 20 would display blank areas above and below the image generally centered in the viewing area. If the image ratio is less than the display unit ratio, the display unit 20 would display blank areas to the left and right of the image in the viewing area.

The stretching module 103 is configured to stretch the image if the image ratio doesn't match the display unit ratio. In detail, the stretching module 103 stretches the image so as to make a size of the image match a size of the display unit 20 to cover the display area of the display unit. For example, if the size of the display unit 20 is 16 n units×9 n units (n=1, 2, 3, . . . ) and the size of the image is 12 n units×9 n units (n=1, 2, 3, . . . ), then the stretching module 103 stretches the length of the image to 16 n units (n=1, 2, 3, . . . ), accordingly, the size of the stretched image is equal to the size of the display unit 20. The blurring module 104 is configured to blur the stretched image. Typically, the blurring module 104 applies a blurring filter (not shown) to blur the whole stretched image. The blurring filter can be a Gaussian blur filter, a mosaic blur filter, and the like.

In other embodiments, the blurring module 104 may be configured to blurs only parts of the stretched image corresponding to the blank areas of the display unit 20. For example, the blurring module 104 determines the blank areas of the display unit 20 when the image ratio doesn't match the display unit ratio, and blurs the parts of the stretched image corresponding to the blank areas.

The combination module 105 is configured to cover the blurred image with the original image to form a combined image. The combined image includes a blurred image part and an original image part. The blurred image part is a part of the blurred image that is displayed in what would otherwise be the blank areas of viewing area, and the original image part is the original image. Because the tone of the blurred image part is similar to the original image, the contrast between the original image and the blank areas is minimized.

The display controlling module 106 is configured to control the display unit 20 to display images. If the image ratio matches the display unit ratio, the display controlling module 106 controls the display unit 20 to display the image directly without adjustment. If the image ratio does not match the display unit ratio, the display controlling module 106 controls the display unit 20 to display the combined image after the combination module 105 generates the combined image.

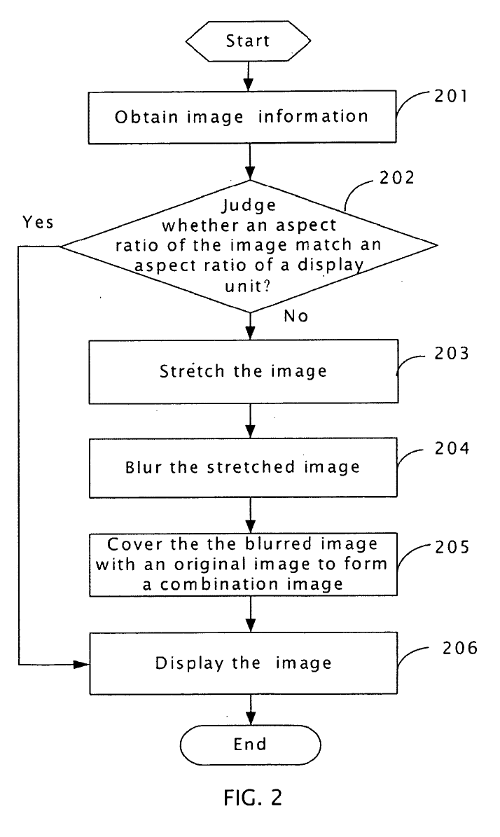

FIG. 2 is a flowchart illustrating a method for processing the image applied in the electronic device 1 according to an exemplary embodiment. In step S201, the obtaining module 101 obtains the information of the image when the input unit 50 generates the instruction to display the image in response to the operation thereon.

In step S202, the comparison module 102 obtains the image ratio according to the information of the image and the display unit ratio, and compares the image ratio with the display unit ratio.

If the image ratio doesn't match the display unit ratio, in step S203, the stretching module 103 stretches the image so as to make a size of the image equal to a size of the viewing area of the display unit 20.

In step S204, the blurring module 104 applies the blurring filter to blur the stretched image and obtains the blurred image.

In step S205, the combination module 105 covers the blurred image with the original image and forms a combined image.

In step S206, the display controlling module 106 controls the display unit 20 to display the combined image.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An electronic device capable of processing image, the electronic device comprising:
an input unit configured to generate instructions in response to user's operations;
a storage unit configured to store images;
a display unit configured to display the images;
a processing unit comprising:
an obtaining module configured to obtain information of one of the images when the input unit generates an instruction to display the image in response to an operation;
a comparison module configured to obtain an aspect ratio of the image according to the information of the image and an aspect ratio of the display unit and compare the aspect ratio of the image with the aspect ratio of the display unit;
a stretching module configured to stretch the image in order to cover the display area of the display unit if the aspect ratio of the image does not match the aspect ratio of the display unit;
a blurring module configured to blur the stretched image;
a combination module configured to cover the blurred image with the original image to form a combined image;
a display control module configured to control the display unit to display the combined image.

2. The electronic device of claim 1, wherein the blurring module blurs the whole image.

3. The electronic device of claim 1, wherein the blurring module blurs a part of the stretched image corresponding to blank areas that are generated when the aspect ratio of the image does not match the aspect ratio of the display unit.

4. The electronic device of claim 2, wherein the blurring module blurs the image through a blur filter, and the blur filter is selected from the group consisting of a Gaussian blur filter and a mosaic blur filter.

5. The electronic device of claim 3, wherein the blurring module blurs the image through a blur filter, and the blur filter is selected from the group consisting of a Gaussian blur filter and a mosaic blur filter.

6. A method for processing an image before the image is displayed on a display unit of an electronic device, the method comprising:
obtaining information of an image when an instruction to display the image is received;
comparing an aspect ratio of the image with an aspect ratio of the display unit;
stretching the image if the aspect ratio of the image does not match the aspect ratio of the display unit in order to cover the display area of the display unit;
blurring the stretched image;
covering the blurred image with the original image to form a combined image;
displaying the combined image on the display unit.

7. The method of claim 6, wherein the step of blurring the stretched image comprises:
blurring the whole stretched image.

8. The method of claim 7, wherein the step of blurring the stretched image further comprises:
determining blank areas of the display unit;
blurring parts of the stretched image corresponding to the blank areas of the display unit.
